(19) United States
(12) Patent Application Publication
(10) Pub. No.: US 2019/0244148 A1
(43) Pub. Date: Aug. 8, 2019

(54) COMPUTER ARCHITECTURE FOR CHARACTERIZING AND MANAGING RISK

(71) Applicant: GeminiRE, Palm Beach Gardens, FL (US)

(72) Inventors: Jeffrey Bernard Scott, Palm Beach Garden, FL (US); Subhashish Dutta, Palm Beach Gardens, FL (US); Peter Laurence Forester, Palm Beach Gardens, FL (US); Jennifer Lee Gravelle, Palm Beach Gardens, FL (US); Douglas Bruce Collins, Palm Beach Gardens, FL (US); Travis Cole Rosecrans, Palm Beach Gardens, FL (US)

(21) Appl. No.: 16/270,984

(22) Filed: Feb. 8, 2019

Related U.S. Application Data
(60) Provisional application No. 62/627,959, filed on Feb. 8, 2018.

(51) Int. Cl. G06Q 10/06; G06N 20/00

(52) U.S. Cl. CPC G06Q 10/0635; G06N 20/00

(57) ABSTRACT

A system, method and program product for optimizing a risk transfer strategy for a resource provider. A system is disclosed having: an interface for accessing event data from a resource provider; a machine learning system that analyzes the event data at different risk levels and detects and quantifies negative correlations among the different risk levels; and a risk transfer optimization system that generates an optimized risk transfer strategy for the resource provider based on detected negative correlations.

### TECHNICAL FIELD

The subject matter of this invention relates to a machine learning platform for characterizing risks associated with a selected domain and an associated architecture for deploying a risk transfer solution, and more particularly relates to identifying and exploiting risks having negative correlations.

### BACKGROUND

In all technology based domains, resources such as software, hardware, devices, property, etc., are subject to risk of failure or loss. For example, a server farm or data center faces risks involving power losses, hardware failures, security breaches, etc. In an autonomous vehicle fleet, vehicles can fail or be involved in an accident. To address this, providers must provision back-up assets to handle such risks for stakeholders. Thus, when a resource failure occurs, back-up systems, pools, redundancies, insurance, etc., are in place to meet the needs of a stakeholder responsible for the resource. In one approach, the risk associated with a resource can be transferred from a provider to one or more other entities, which allows for more efficient handling of larger risk pools.

For example, a group of servers may utilize an automated IT service in which the entire server farm is configured to roll over to a larger cloud platform in the event of a catastrophic failure. The risk of smaller failures (e.g., bad server disk on a single machine) can likewise be backed-up by a cloud service, in a case-by-case manner. Ideally, all types of risks should be managed by a single provider responsible for managing the transfer of risk, thereby simplifying risk management for the stakeholders and provider.

One of the challenges in such risk transfer environments is that there are different approaches for dealing with different types of risk. Accordingly, optimally determining the right balance of coverage when implementing a comprehensive risk transfer strategy remains a challenge for providers.

### SUMMARY

Aspects of the disclosure provides a machine learning platform for characterizing risks associated with a selected domain and an associated system for optimizing and deploying a risk transfer solution. A machine learning platform may be employed to identify and quantify negative correlations among different risk categories, which are then used to optimize a risk transfer process within the domain. Accordingly, a technical solution of optimizing a risk transfer process is provided to improve system performance in any selected domain.

A first aspect discloses risk management processor for optimizing a risk transfer strategy for a resource provider, comprising: an interface for accessing event data from a resource provider; a machine learning system that analyzes the event data at different risk levels and detects and quantifies negative correlations among the different risk levels; and a risk transfer optimization system that generates an optimized risk transfer strategy for the resource provider based on detected negative correlations.

A second aspect discloses a method for optimizing a risk transfer strategy for a resource provider within a domain, comprising: accessing event data from a resource provider; analyzing the event data at a high risk level and a low risk level; clustering event data within the low risk level based on domain level event data to generate a set of clusters; detecting negative correlations between event data in the set of clusters and event data in the high risk level; and generating an optimized risk transfer strategy for the resource provider based on detected negative correlations.

A third aspect discloses a computerized platform for managing risk for resource providers, comprising: a non-catastrophic risk analyzer that: evaluates historical event data from a resource provider to determine frequency and volatility data; generates a set of clusters of event data based on industry event data; applies the frequency and volatility data to selected clusters to determine cost and risk parameters; sets boundaries conditions to the cost and risk parameters; and generates a non-catastrophic risk transfer strategy; a catastrophic risk analyzer that generates a catastrophic risk transfer strategy based on budget and threshold requirements; and a risk transfer optimization system that iteratively recalibrates and combines the non-catastrophic and catastrophic risk transfer strategies into a comprehensive risk transfer strategy until an optimized result is achieved, wherein a recalibration includes altering the cost and risk parameters and the catastrophic risk transfer strategy.

A fourth aspect provides a program product for providing risk management.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a risk management processor being applied to a domain.

FIG. 2 shows an overview of a risk transfer architecture according to embodiments.

FIG. 3 shows a flow diagram of risk transfer process according to embodiments.

FIG. 4 shows a detailed embodiment of a risk transfer process according to embodiments.

FIG. 5 depicts an overview of a machine learning process for discovering probabilistic correlations according to embodiments.

FIG. 6 depicts a computing system having a risk transfer processor according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

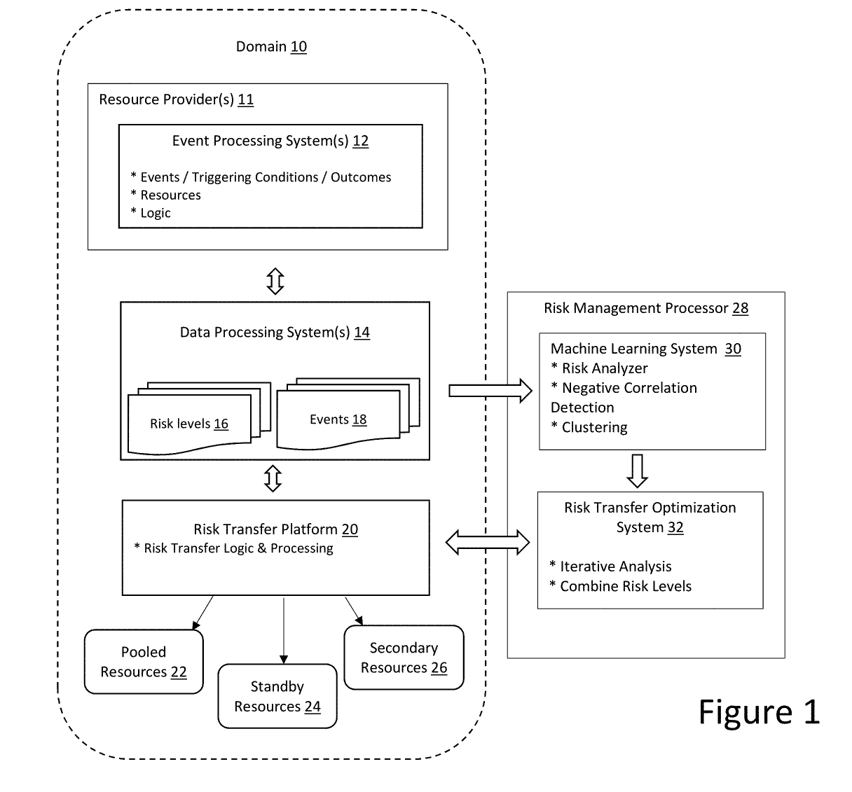

Referring now to the drawings, FIG. 1 depicts a risk management processor 28 being applied to a domain 10 to improve risk transfer processing. Domain 10 may comprise any technology or industry domain, e.g., cloud computing, autonomous fleet management, energy management, manufacturing, data security, health care, insurance, etc., in which resource providers 11 provide resources to entities within the domain 10. Domain 10 is further configured such that risks associated with resources in the domain may be shared, pooled and/or transferred among other providers 11 within the domain. In this embodiment, risk management processor 28 is intended to be domain-agnostic, i.e., capable of integrating to a data processing system 14 within any domain 10 that has the above characteristics.

In this illustrative embodiment, resource providers 11 generally deploy one or more event processing systems 12 within the domain 12. A typical event processing system 12 may for example be an enterprise software system that includes logic for processing events associated with resources of the provider 11. Events generally comprise some type of occurrence that adversely impact the resource provider 11. A typical event may for example include a triggering condition (e.g., a memory failure, an accident, an overloads, acts of natures, etc.) and an outcome (e.g., downtime, losses, decreased output, replacement costs, etc.).

Various data processing systems 14 may be deployed to capture, store and analyze event data associated with the one or more event processing systems 12 within the domain 10. In this case, data processing system 14 is deployed to capture and process event data, which includes tracking events 18 that are assigned to or associated with different risk levels 16. Risk levels 16 may for example range from high impact risks that impact a large number of resources to low impact risks that impact fewer resources. Thus, in a particular domain 10, events 18 may occur that fall into different risk levels, and have associated outcomes that are tracked and analyzed.

In order to manage the risks associated with different events 18, a risk transfer platform 20 is provided that includes logic and processing to ensure that all different risk levels 16 have a strategy for handling all the different types of events 18 that might be encountered by a resource provider 11. For example, risk transfer platform 20 may arrange for backup resources such as pooled resources 22, standby resources 24, secondary resources 26, etc., to be made available as needed when the resource provider 11 cannot handle a volume or type of events. In this manner, the resource provider 11 itself need not be entirely responsible for providing all the resources necessary to handle all the events 18 it might encounter.

To optimize and exploit the risk transfer process, a risk management processor 28 is provided which may include a machine learning system 30 and a risk transfer optimization system 32. In this illustrative embodiment, machine learning system 30 interfaces with data processing system 14 to analyze risk levels 16 and events 18 (as well as other data such as risk profiles) over time to detect and quantify negative correlations among different risk categories. Negative correlations generally refer to situations where a given behavior in a first risk category is associated or correlated with a corresponding opposite behavior in a second risk category. For example, it may be detected that during periods where a high number of events occur at the first risk category, a low number of events generally occur at the second risk category, and vice versa. Machine learning system 30 may for example deploy a neural network or other artificial intelligence system to predict and quantify probabilities of a negative correlation between any two risk categories based on event data captured from one or more data processing systems 14.

In one approach, machine learning system 30 clusters event data for one or more risk levels. Clusters may be determined based on any variables, e.g., location, time, conditions, interactions, etc. Each cluster (i.e., risk category) within a risk level can thereafter be evaluated against other risk levels or categories to detect negative correlations at a granular level.

In response to the detection and quantification of negative correlations, risk transfer optimization system 32 is employed to generate a risk transfer logic in the risk transfer platform 20 that takes advantage of the negative correlation or arbitrage. For instance, assume that for a resource provider 11, a first risk level requires X backup resources (e.g., memory, transportation assets, energy, capital, etc.) and a second risk level requires Y backup resources. The total number of backup resources R required is therefore: R=X+Y. If however, the two risk categories are known to be negatively correlated, risk transfer platform 20 can deploy fewer backup resources 24 while still meeting the statistical demands of the system. The reason is that in cases where risk categories are negatively correlated, the likelihood of a resource provider experiencing a large number of events 18 at both risk levels at the same time is statistically diminished. Thus, where a negative correlation is detected, the total number of backup resources required is: R<X+Y.

It is understood that resources may comprise any type of computing assets (e.g., memory, cpu, network, etc.), data, communication systems, manufacturing assets, transportation assets, Internet of Things (IoT) devices, capital, property, agreements, etc. For example, resources may comprise a network of geographically dispersed servers controlled by a set of stakeholders. Risk management processor 28 can be utilized by a resource provider 11 to assess different types of risk categories, determine an optimized number of back-up servers required for a group of risk categories, and automatically arrange for back-up servers in the event of a failure. In a further example, resources may comprise a network of autonomous vehicles tasked with transporting goods between cities. Risk management processor 28 can be utilized by providers 11 to assess risks, calculate an optimized number of replacement parts, repair services, etc., to handle events consisting of accidents and breakdowns. In a third example, events may comprise claims data associated with a provider of insurance products, and risk management processor 28 can be utilized by the provider to assess risk levels, and determine an optimal amount of re-insurance to handle different risk pools.

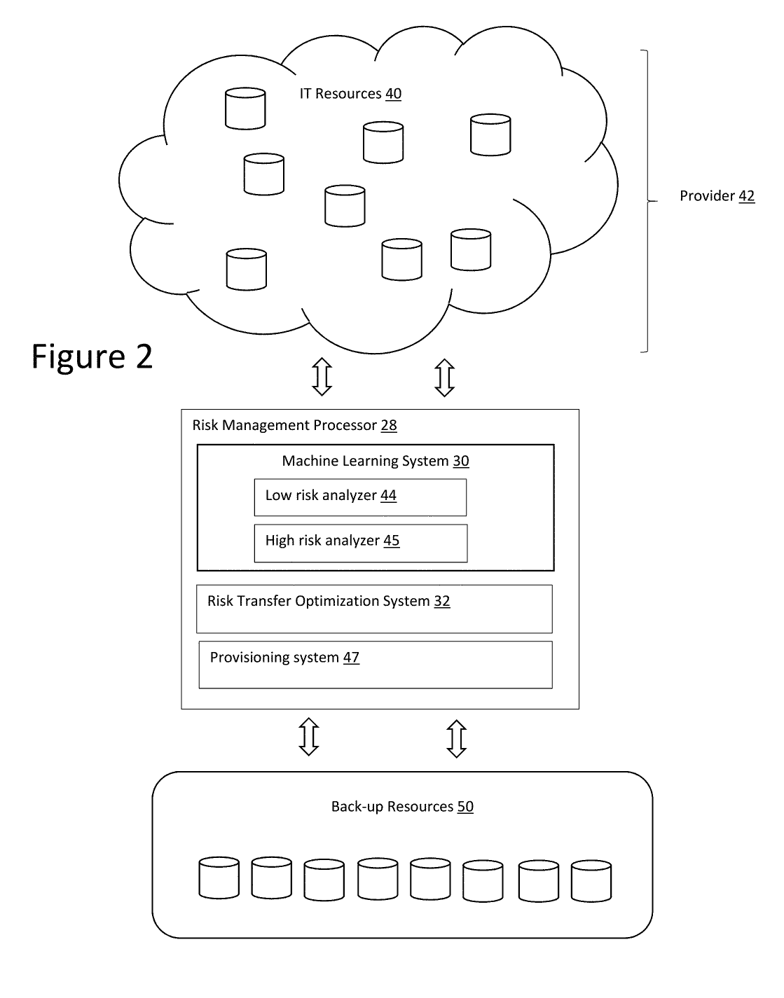

FIG. 2 depicts a risk management architecture for a set of information technology (IT) resources 40 for a provider 42. In this embodiment, risk management processor 20 is utilized to capture event and other data associated with the IT resources 30 to package back-up resources 50 based on an optimized risk transfer strategy. Risk management processor 28 may be integrated with the IT resources 40, integrated as part of back-up resources 50, or be implemented as a stand-alone product or service by third party provider (e.g., an automated agent, an IT provider, a broker, etc.). Risk management processor 28 determines and provisions an optimized amount of back-up resources 50 to handle predicted events (e.g., failures), while maximizing cost savings. For the purposes of this example, the term “event” may include any damage, losses, downtime, etc. associated with IT resources 40.

Because there is significant flexibility and options associated with implementing back-up resources 50, risk management processor 28 is configured to optimize a risk transfer strategy that provides a required amount of back-up assets for a set of risk categories in a cost optimized manner. In typical practice, different types of risk (risk levels) are covered with different back-up strategies. In the present approach, a comprehensive risk transfer strategy is determined that combines multiple types of risk. In this illustrative example, risk management processor 28 is implemented to handle two levels of risk and includes a low risk analyzer 44 that analyzes low impact, non-catastrophic event data (e.g., crashes, minor hardware failures, etc.) and a high risk analyzer 45 that analyzes high impact, catastrophic event data (e.g., major hardware failures, system wide outages, major security breaches, etc.) associated with the IT resources 40. The low risk analyzer 44 and high risk analyzer 45 may be implemented using a machine learning system 30, or any other type of data analyzer, in order to identify and quantify negative correlations. As noted, at least one of the risk levels (e.g., the low risk level) can be segmented into clusters. Each of the clusters, e.g., in the low risk level, can be iteratively combined with the high risk level to more granularly detect and exploit negative correlations.

Negative correlations may be time dependent (e.g., they occur during different times of the day or year), location dependent (e.g., they occur more frequently in different geolocations), condition dependent (e.g., weather, wind, solar, etc.), etc. Once identified and quantified, risk transfer optimization system 32 determines an optimized backup strategy (e.g., an amount of back-up resources, hardware, memory, CPU bandwidth, etc.) 50 that can meet requirements for the combination. A provisioning system 47 may be utilized that automatically provisions (e.g., arranges, contracts for, etc.) the back-up resources 50 based on the optimized risk transfer strategy. In the event of a system failure, risk management processor 28 may also manage the deployment of the back-up resources 50.

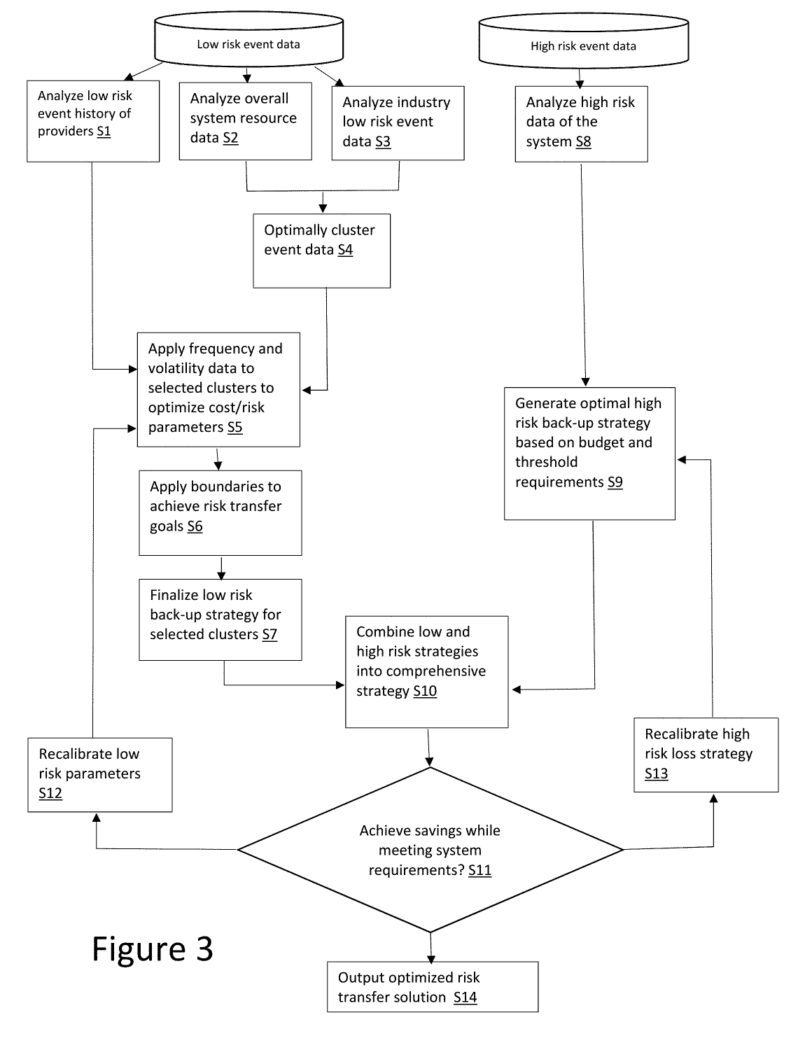

FIG. 3 depicts a flow chart of a process for implementing risk management processor 28. At S1, the event history of providers 11 within a domain (FIG. 1) is analyzed, e.g., to determine the frequency and volatility of past events (i.e., create a low risk profile). The event history may be stored in a dedicated database, e.g., based on log files, claims records, etc. At S2, the overall system resource data is analyzed, e.g., total number of resources, types of resources, location of resources, value of resources, etc., and at S3, industry event data for related providers is analyzed. At S4, the system analysis and industry analysis is evaluated to optimally identify and cluster related groups of events within the system, e.g., based on type, location, value, etc.

Next, at S5, frequency and volatility data is applied to selected clusters to optimize cost and risk parameters. Given the risk profile of a given cluster, a determination is made regarding the predicted amount of back-up assets that will be incurred over a time period (e.g., a year) for the cluster. An associated pricing model to obtain and provide the back-up assets may also be established to create a back-up strategy. At S6, boundaries are applied to each cluster's back-up strategy. In other words, based on a pricing model, limitations to the total amount of back-up assets that will be provided are set for the time period. At S7, a low risk back-up strategy for selected clusters is finalized and outputted.

Returning to the top right of the flow chart, high risk event data of the system is analyzed at S8, and at S9, an optimal high risk back-up strategy is generated based, e.g., on budget and threshold requirements. For instance, the provider responsible for backing up resources may allocate a certain spend amount for high risk failures that will meet design protocols, contractual obligations and/or statutory requirements. At S10, the low and high risk strategies are combined into a single comprehensive strategy, with the goal of reducing the total cost of obtaining back-up assets. At S11, a determination is made whether the savings is achieved while meeting all the requirements of the given domain. In practice, an overall savings is obtainable because of a negative correlation that exists between different combined risk categories. In general, if a system of resources experiences a catastrophic failure over a time period, then the system will likely be subject to fewer non-catastrophic failures, and vice versa. Accordingly, by combining the two strategies together, fewer back-up assets are required than if obtained separately. If a projected savings is not achieved after the two are combined, the low and high risk back-up strategies are recalibrated at S12 and S13, respectively, and the process iterates until a savings is realized. Once the savings is achieved at S11, the optimized risk transfer solution can be output at S14.

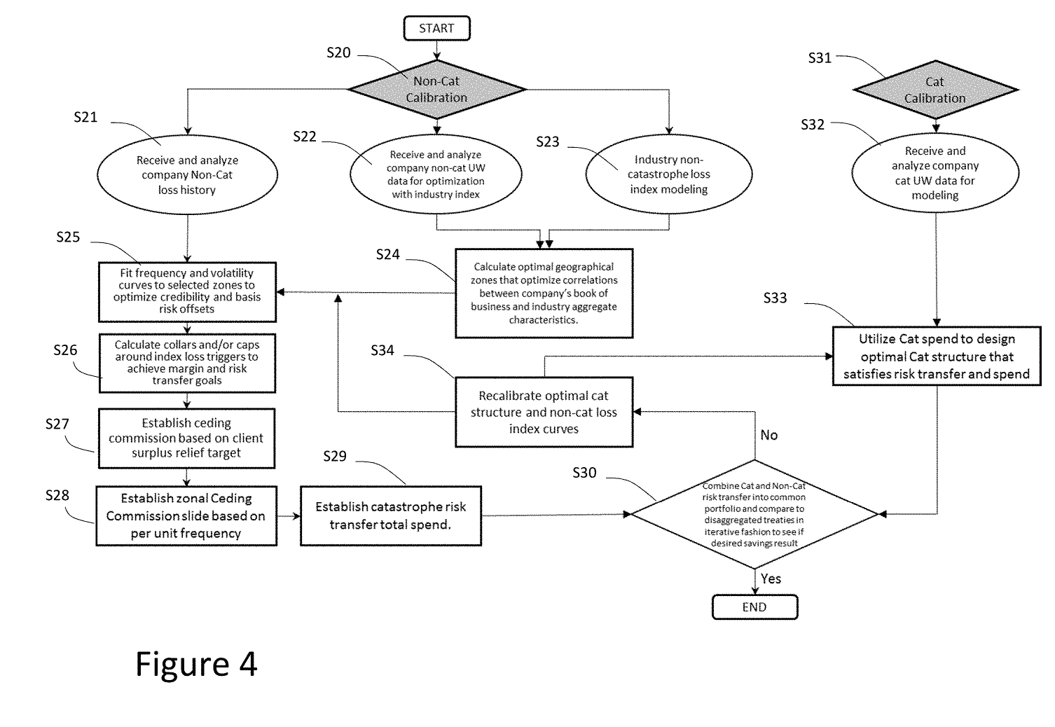

FIG. 4 depicts an embodiment of the risk transfer processor 28 for use with an event processing system that provisions insurance resources. In this case, it allows a provider (e.g., insurance company) to optimize re-insurance levels. Typically, property can be insured with insurance products that cover all types of risk events, e.g., catastrophic and non-catastrophic, by a provider (i.e., broker) that utilizes a re-insurance market to obtain coverage for a large pool of stakeholders (i.e., property owners). Event data (i.e., claims, payments, etc.) are process by an event processing system 12 of the provider and resulting data is made available, e.g., via a database.

In this example, a non-catastrophic calibration is performed at S20 and a catastrophic calibration is performed at S31. Beginning with the non-catastrophic calibration, non-catastrophic loss history of the company is received and analyzed at S21; non-catastrophic underwriting (UW) data of the company is received and analyzed at S22; and industry non-catastrophic loss index modeling is obtained at S23. At S24, the data from S22 and S23 is processed to calculate a set of geographic zones that optimize correlations between the company's business and industry aggregate characteristics.

At S25, the results from S21 and S24 are utilized to fit frequency and volatility curves to selected zones to optimize credibility and basis risk offsets. Next, at S26, collars and/or caps are calculated around index loss triggers to achieve margin and risk transfer goals. At S27, a ceding commission is established based on a client surplus relief target, and at S28 a zonal ceding commission is established based on per unit frequency. At this point, the non-catastrophic strategy is completed and a catastrophic risk transfer total spend is established at S29.

Returning to the top right, catastrophic underwriting (UW) data of the company is received and analyzed for modeling purposes at S32. At S33, the catastrophic spend is utilized to design an optimal catastrophic structure that satisfies risk transfer requirements. At S30, the non-catastrophic and catastrophic plans are combined and compared to disaggregated treaties (i.e., if determined separately) to see if a desired savings result. If no, the optimal catastrophic structure and non-catastrophic loss index curves are recalibrated at S34. The process iterates until the desired savings are achieved.

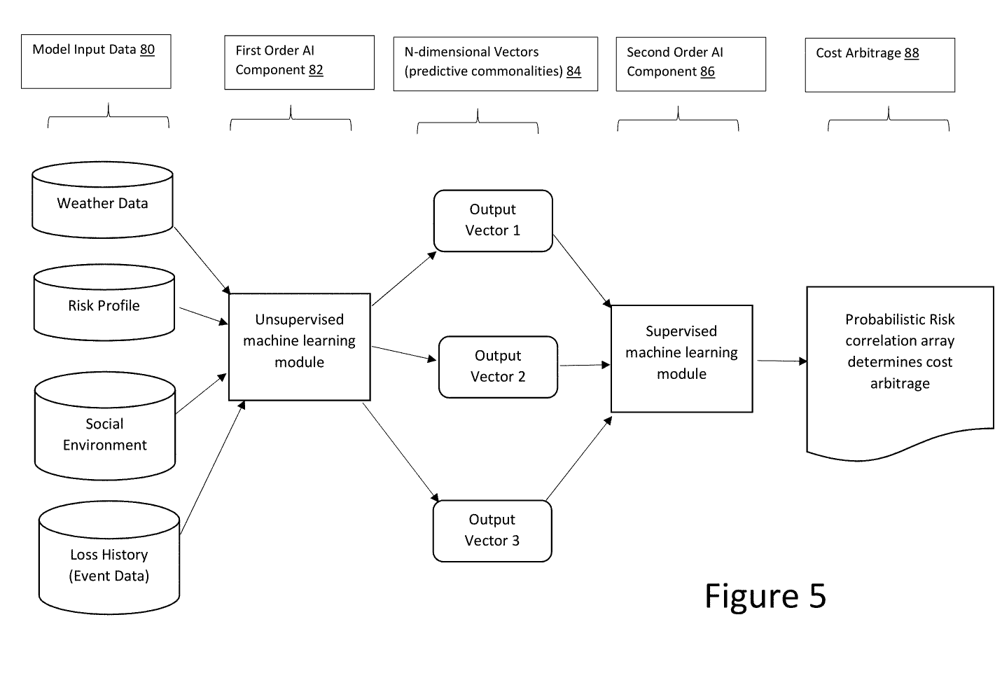

FIG. 5 depicts a flow diagram of artificial intelligence (AI) process for determining probabilistic risk correlations to identify a negative correlation that results in a cost arbitrage. As shown, model input data 80 is input into a first order AI component (i.e., an unsupervised machine learning module). In addition to loss history (i.e., event data), additional information such as weather data, risk profile data, social environment data, etc., may be input. The unsupervised machine learning identifies commonalities (e.g., clusters) in the model data inputs 80 allowing for second-order analysis. When optimal classifications have been determined, a second order artificial intelligence component 86 calculates a spectrum of probabilistic negative correlations that can be used to determine the cost arbitrage. In this case, an array of correlation outcomes can be generated, e.g., consisting of a first set of risk categories along a first axis and a second set of risk categories along a second access. Combinations that produce the greatest negative correlations can for example be packaged at a cost that is less than if they were packaged separately. The competitive advantage of the cost module is based on arbitrage of less than perfectly correlated risk categories.

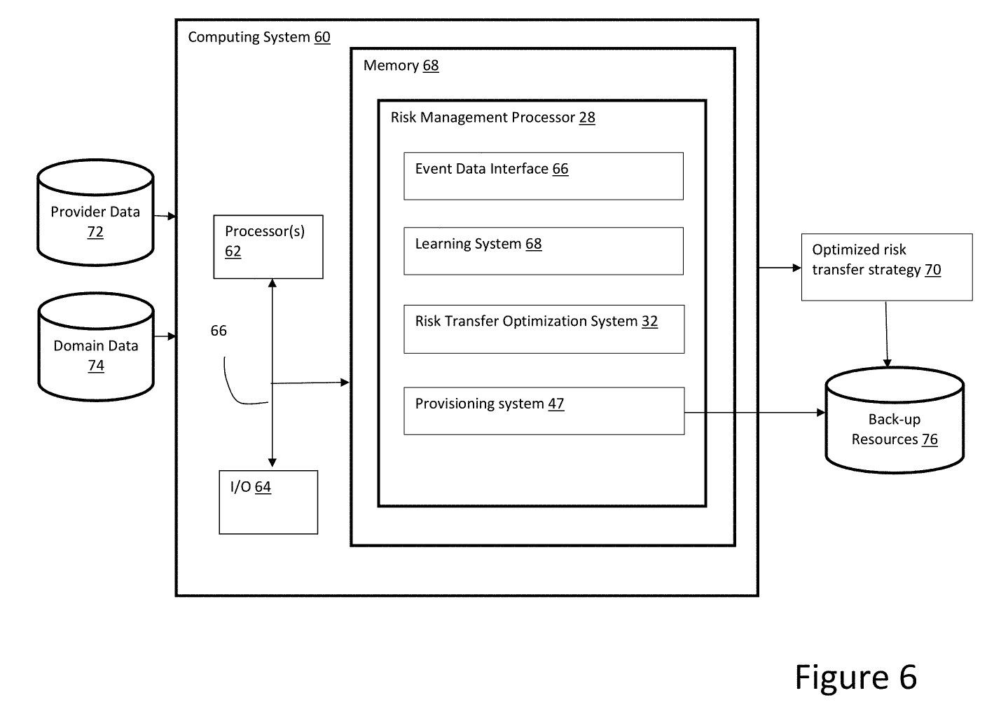

FIG. 6 depicts risk management processor 20 implemented by a computing system 10. In this embodiment risk management processor 20 receives provider data 72 and industry data 74 and outputs an optimized risk transfer strategy 70 that is utilized to provision back-up resources 76. Provider data 42 generally comprises data associated with events being managed by a provider. Domain data 74 generally include event data across an entire industry.

Risk management processor 28 generally includes an event data interface for collecting event data from provider data 72 and domain data 74; a learning system 68 that identifies and quantifies negative correlations among different risk categories, a risk transfer optimization system 32 that generates an optimized risk transfer strategy 70; and a provisioning system 47 that interfaces with back-up resources 76.

It is understood that risk management processor 28 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 60 may comprise any type of computing device and for example includes at least one processor 62, memory 68, an input/output (I/O) 64 (e.g., one or more I/O interfaces and/or devices), and a communications pathway 66. In general, processor(s) 62 execute program code which is at least partially fixed in memory 68. While executing program code, processor(s) 62 can process data, which can result in reading and/or writing transformed data from/to memory and/or I/O 64 for further processing. The pathway 66 provides a communications link between each of the components in computing system 60. I/O 64 can comprise one or more human I/O devices, which enable a user to interact with computing system 60. Computing system 60 may also be implemented in a distributed manner such that different components reside in different physical locations.

Furthermore, it is understood that the risk management processor 28 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A risk management processor for optimizing a risk transfer strategy within a domain of resource providers, comprising:
an interface for accessing event data from a resource provider;
a machine learning system that analyzes the event data at different risk levels and detects and quantifies negative correlations between the different risk levels; and
a risk transfer optimization system that generates an optimized risk transfer strategy for the resource provider based on detected negative correlations.

2. The risk management processor of claim 1, wherein the interface further accesses industry wide event data.

3. The risk management processor of claim 2, wherein the machine learning system uses the industry wide event data to cluster event data within at least one risk level to generate a set of clusters.

4. The risk management processor of claim 3, wherein the machine learning system identifies negative correlations between clusters in the at least one risk level and other risk levels.

5. The risk management processor of claim 4, wherein the clusters include at least one of location based clusters and time based clusters.

6. The risk management processor of claim 1, wherein the negative correlations involve an opposite behavior pattern of event data.

7. The risk management processor of claim 1, wherein the risk transfer optimization system iteratively combines, recalibrates and tests different combinations of clusters and risk levels until a cost savings is achieved.

8. A method for optimizing a risk transfer strategy for a resource provider within a domain, comprising:
accessing event data from a resource provider;
analyzing the event data at a high risk level and a low risk level;
clustering event data within the low risk level based on domain level event data to generate a set of clusters;
detecting negative correlations between event data in the set of clusters and event data in the high risk level; and
generating an optimized risk transfer strategy for the resource provider based on detected negative correlations.

9. The method of claim 8, wherein the domain level event data comprises industry event data.

10. The method of claim 8, wherein the clusters include at least one of location based clusters and time based clusters.

11. The method of claim 8, wherein the negative correlations involve an opposite behavior pattern of event data within the high and low risk levels.

12. The method of claim 8, wherein generating the risk transfer strategy includes iteratively combining, recalibrating and testing different risk levels and clusters until an optimal result is achieved.

13. The method of claim 8, wherein the resource provider is selected from a group consisting of: an information technology provider, a cloud resource provider, an autonomous vehicle service, a manufacturer, an energy provider, and an insurance provider.

14. The method of claim 8, wherein event data includes events having a triggering condition and an outcome.

15. A computerized platform for managing risk for resource providers, comprising:
a non-catastrophic risk analyzer that:
evaluates historical event data from a resource provider to determine frequency and volatility data;
generates a set of clusters of event data based on industry event data;
applies the frequency and volatility data to selected clusters to determine cost and risk parameters;
sets boundaries conditions to the cost and risk parameters; and
generates a non-catastrophic risk transfer strategy;
a catastrophic risk analyzer that generates a catastrophic risk transfer strategy based on budget and threshold requirements; and
a risk transfer optimization system that iteratively recalibrates and combines the non-catastrophic and catastrophic risk transfer strategies into a comprehensive risk transfer strategy until an optimized cost savings is achieved, wherein a recalibration includes altering the cost and risk parameters and the catastrophic risk transfer strategy.

16. The computerized platform of claim 15, wherein the clusters include at least one of location based clusters and time based clusters.

17. The computerized platform of claim 15, wherein an optimized result is achieved when a negative correlation occurs.

18. The computerized platform of claim 17, wherein a negative correlation occurs in response to opposite behavior patterns of event data within non-catastrophic and catastrophic event data.

19. The computerized platform of claim 15, wherein the resource provider is selected from a group consisting of: an information technology provider, a cloud resource provider, an autonomous vehicle service, a manufacturer, an energy provider, and an insurance provider.

20. The computerized platform of claim 15, wherein event data is selected from a group consisting of: failures, overloads, accidents, breakdowns, or claims.
